(19) United States
(12) Patent Application Publication
(10) Pub. No.: US 2025/0220451 A1
(43) Pub. Date: Jul. 3, 2025

(54) BEAM PREDICTION AT A REPEATER DEVICE

(71) Applicant: QUALCOMM Incorporated, San Diego, CA (US)

(72) Inventors: Tianyang BAI, Mountain View, CA (US); Hua WANG, Basking Ridge, NJ (US); Navid ABEDINI, Basking Ridge, NJ (US); Junyi LI, Fairless Hills, PA (US)

(21) Appl. No.: 18/400,790

(22) Filed: Dec. 29, 2023

(51) Int. Cl. H04W 16/28; H04L 5/00; H04W 24/10

(52) U.S. Cl. CPC H04W 16/28; H04L 5/0051; H04W 24/10

(57) ABSTRACT

Various aspects of the present disclosure generally relate to wireless communication. In some aspects, a repeater device may communicate with a user equipment (UE) using a first beam, the communicating comprising relaying an access link communication between the UE and a network node. The repeater device may use a second beam that is predicted by the repeater device to communicate with the UE, the second beam being based at least in part on a network operating condition. Numerous other aspects are described.

### FIELD OF THE DISCLOSURE

Aspects of the present disclosure generally relate to wireless communication and specifically relate to techniques, apparatuses, and methods for beam prediction at a repeater device.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a repeater device. The method may include communicating with a user equipment (UE) using a first beam, the communicating comprising relaying an access link communication between the UE and a network node. The method may include using a second beam that is predicted by the repeater device to communicate with the UE, the second beam being based at least in part on a network operating condition.

Some aspects described herein relate to an apparatus for wireless communication at a repeater device. The apparatus may include one or more memories and one or more processors coupled to the one or more memories. The one or more processors may be configured to communicate with a UE using a first beam, the communicating comprising relaying an access link communication between the UE and a network node. The one or more processors may be configured to use a second beam that is predicted by the repeater device to communicate with the UE, the second beam being based at least in part on a network operating condition.

Some aspects described herein relate to a non-transitory computer-readable medium that stores a set of instructions for wireless communication by a repeater device. The set of instructions, when executed by one or more processors of the repeater device, may cause the repeater device to communicate with a UE using a first beam, the communicating comprising relaying an access link communication between the UE and a network node. The set of instructions, when executed by one or more processors of the repeater device, may cause the repeater device to use a second beam that is predicted by the repeater device to communicate with the UE, the second beam being based at least in part on a network operating condition.

Some aspects described herein relate to an apparatus for wireless communication. The apparatus may include means for communicating with a UE using a first beam, the communicating comprising relaying an access link communication between the UE and a network node. The apparatus may include means for using a second beam that is predicted by the repeater device to communicate with the UE, the second beam being based at least in part on a network operating condition.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating examples of beam management procedures, in accordance with the present disclosure.

FIG. 5 is a diagram illustrating an example of artificial intelligence/machine learning based beam management, in accordance with the present disclosure.

FIG. 6 is a diagram illustrating an example of a repeater device, in accordance with the present disclosure.

FIG. 7 is a diagram illustrating an example of a wireless communication process between a network node, a repeater device, and a UE, in accordance with the present disclosure.

FIG. 7 illustrates an example of a network node fully-controlled operating scenario.

FIG. 8 is a diagram illustrating an example process performed, for example, at a repeater device or an apparatus of a repeater device, in accordance with the present disclosure.

FIG. 9 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A repeater device may be an intermediary device between a network node and a user equipment (UE) that improves line-of-sight (LoS) conditions in signaling between the UE and a network node. While the use of a repeater device may improve LoS conditions, the use of a repeater device may also increase a signaling overhead for beam management procedures and/or beam predictions. To illustrate, the network node may use a first beam to transmit signals to, and/or receive signals from, the repeater device, and the repeater device may use a second beam to transmit signals to, and/or receive signals from, the UE. Based at least in part on a mobility of the UE, the first beam and the second beam may vary from one another in direction based at least in part on the respective locations of the network node, the repeater device, and the UE.

The repeater device and the UE may perform a beam management procedure to select a beam for a communication link between the repeater device and the UE. As one example, the beam management procedure may include sweeping through multiple beams, generating measurements for each beam, communicating the measurements to the network node, and/or receiving a beam configuration from the network node. Based at least in part on a mobility of the UE, the repeater device, the UE, and/or the network node may iteratively and/or periodically perform the beam management procedure and increase a signaling overhead in a wireless network. Increased signaling overhead may result in reduced data throughput and/or increased data transfer latencies. Performing multiple beam management procedures may also introduce delays in data transfer and increase the data transfer latencies.

Various aspects relate generally to beam prediction module updates at a repeater device. Some aspects more specifically relate to a repeater device performing beam prediction for a communication link between the repeater device and a UE. In some aspects, a repeater device may communicate with a UE using a first beam to obtain one or more measurement metrics that indicate a network operating condition, and may predict the second beam using the one or more measurement metrics as input.

Particular aspects of the subject matter described in this disclosure can be implemented to realize one or more of the following potential advantages. In some examples, by a repeater device including a prediction algorithm, the described techniques can be used to reduce signaling overhead in a wireless network, such as by reducing beam sweeps performed by a UE and/or reducing a number of measurement metric(s) that are transmitted by the repeater device to the network node. Reducing signaling overhead may reduce air interface resource consumption, resulting in more air interface resources being available for data transmissions, increase data throughput in a wireless network, and/or decrease data transfer latencies in the wireless network. Alternatively, or additionally, the repeater device using a prediction model to predict a future beam may mitigate delays in a wireless network that are associated with running a beam management procedure at the relay device, and reduce data transfer latencies.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

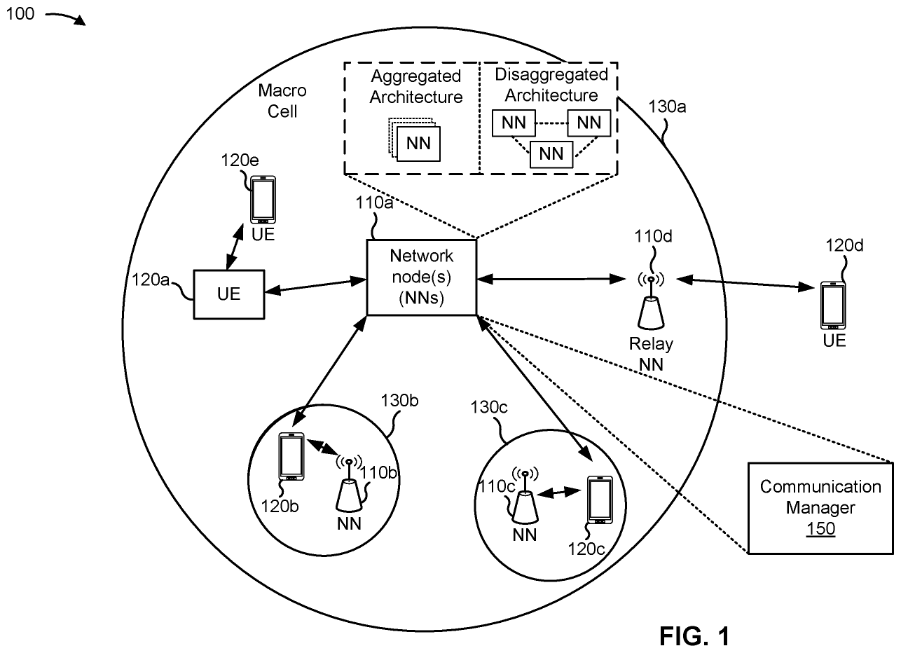

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of ultra-reliable low-latency communication (URLLC), enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some radio access technologies (RATs) may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a repeater device (e.g., a network node 110 and/or an apparatus 900) may include a communication manager 150. As described in more detail elsewhere herein, the communication manager 150 may communicate with a UE using a first beam, the communicating comprising relaying an access link communication between the UE and a network node; and use a second beam that is predicted by the repeater device to communicate with the UE, the second beam being based at least in part on a network operating condition. Additionally, or alternatively, the communication manager 150 may perform one or more other operations described herein.

As indicated above, FIG. 1 is provided as an example. Other examples may differ from what is described with regard to FIG. 1.

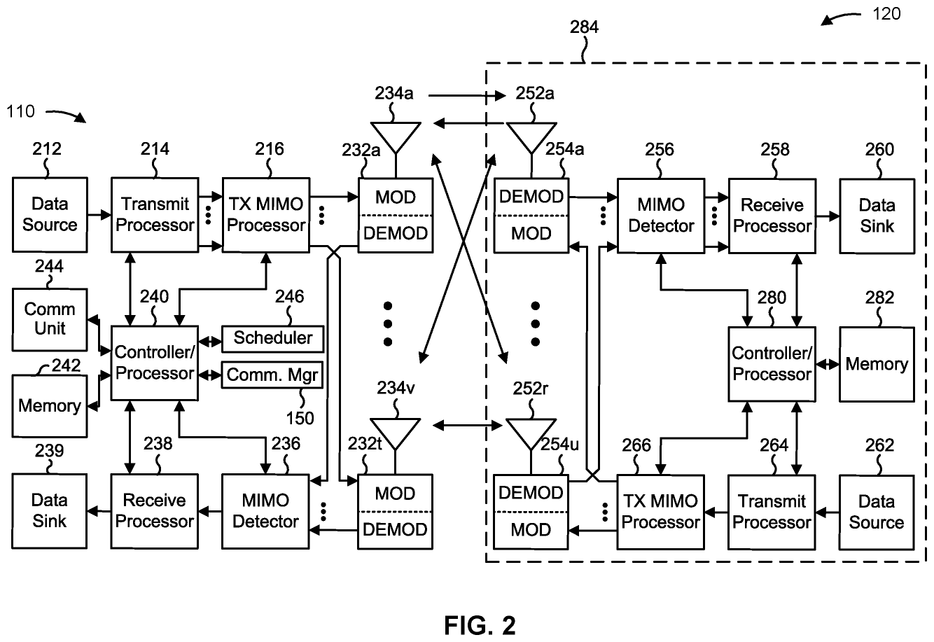

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing ((OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

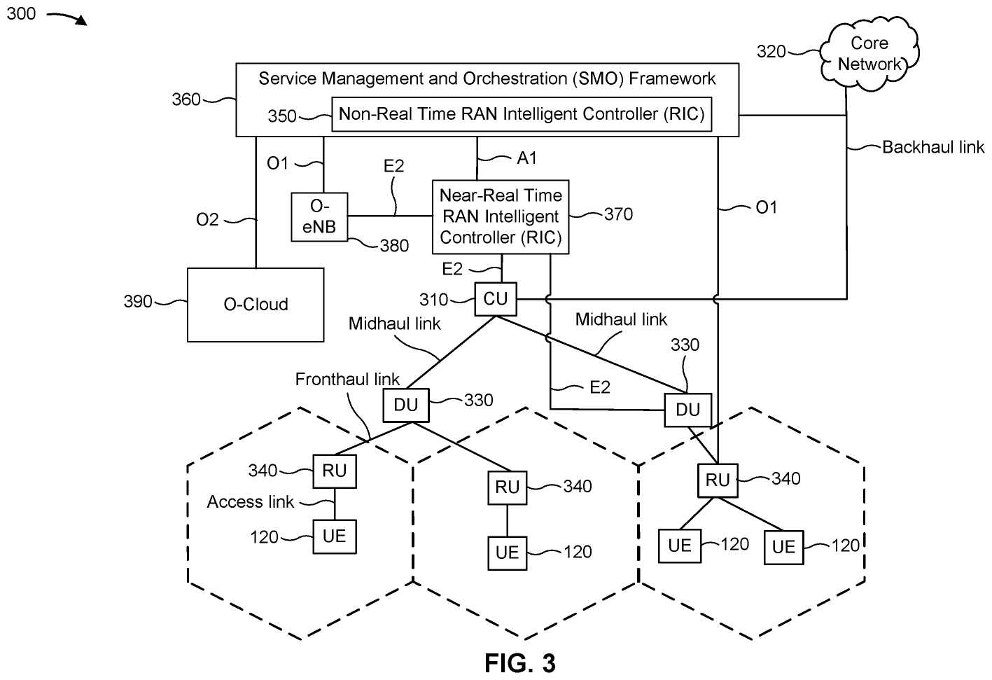

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU-UP units and one or more CU-CP units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

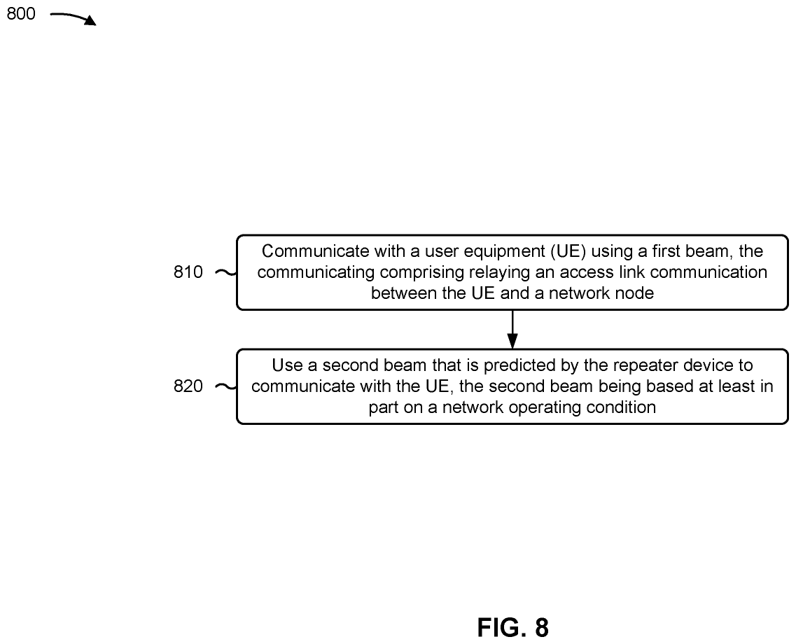

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with beam prediction module updates at a repeater device, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, or other processes as described herein (alone or in conjunction with one or more other processors). In some aspects, the repeater device described herein is a network node 110, is included in the network node 110, or includes one or more components of the network node 110 shown in FIG. 2.

The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, or other processes as described herein. In some examples, executing instructions may include running the instructions, converting the instructions, compiling the instructions, and/or interpreting the instructions, among other examples.

In some aspects, a repeater device (e.g., a network node 110) includes means for communicating with a UE using a first beam, the communicating comprising relaying an access link communication between the UE and a network node; and/or means for using a second beam that is predicted by the repeater device to communicate with the UE, the second beam being based at least in part on a network operating condition. In some aspects, the means for the repeater device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

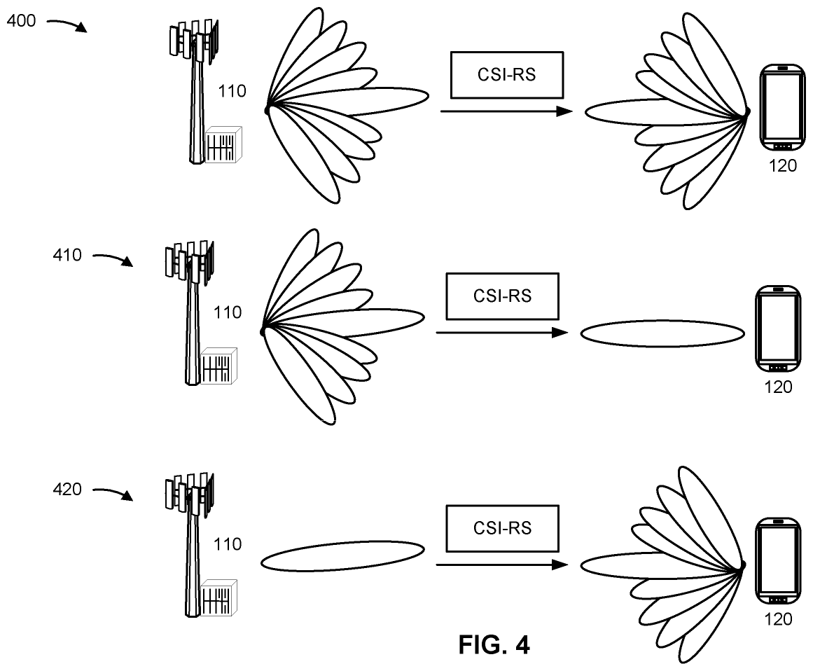

FIG. 4 is a diagram illustrating examples 400, 410, and 420 of beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or transmit receive point (TRP), between a mobile termination node and a control node, between an integrated access and backhaul (IAB) child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using DCI).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same reference signal (RS) resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use synchronization signal blocks (SSBs) for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

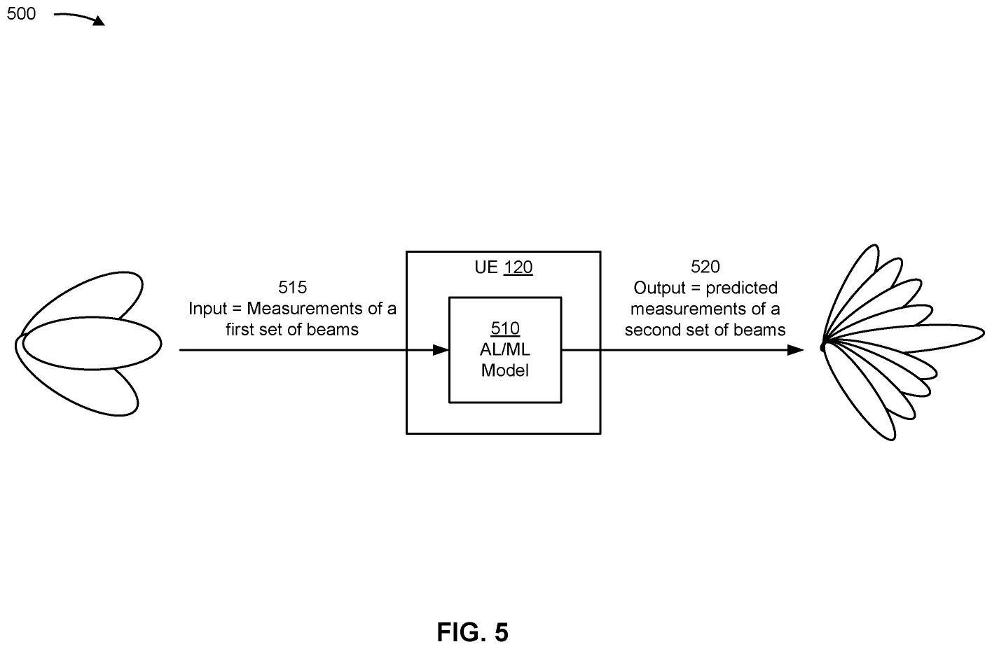

FIG. 5 is a diagram illustrating an example 500 of an AI/ML based beam management, in accordance with the present disclosure. As shown in FIG. 5, an AI/ML model 510 may be deployed at or on a UE 120. For example, a model inference host (such as a model inference host) may be deployed at, or on, a UE 120. The AI/ML model 510 may enable the UE 120 to determine one or more inferences or predictions based on data input to the AI/ML model 510.

For example, as shown by reference number 515, an input to the AI/ML model 510 may include measurements associated with a first set of beams. For example, a network node 110 may transmit one or more signals using respective beams from the first set of beams. The UE 120 may perform measurements (e.g., L1 RSRP measurements or other measurements) of the first set of beams to obtain a first set of measurements. For example, each beam, from the first set of beams, may be associated with one or more measurements performed by the UE 120. The UE 120 may input the first set of measurements (e.g., L1 RSRP measurement values) into the AI/ML model 510 along with information associated with the first set of beams and/or a second set of beams, such as a beam direction (e.g., spatial direction), beam width, beam shape, and/or other characteristics of the respective beams from the first set of beams and/or the second set of beams.

As shown by reference number 520, the AI/ML model 510 may output one or more predictions. The one or more predictions may include predicted measurement values (e.g., predicted L1 RSRP measurement values) associated with the second set of beams. This may reduce a quantity of beam measurements that are performed by the UE 120, thereby conversing power of the UE 120 and/or network resources that would have otherwise been used to measure all beams included in the first set of beams and the second set of beams. This type of prediction may be referred to as a codebook based spatial domain selection or prediction.

As another example, an output of the AI/ML model 510 may include a point-direction, an angle of departure (AoD), and/or an angle of arrival (AoA) of a beam included in the second set of beams. This type of prediction may be referred to as a non-codebook based spatial domain selection or prediction. As another example, multiple measurement report or values, collected at different points in time, may be input to the AI/ML model 510. This may enable the AI/ML model 510 to output codebook based and/or non-codebook based predictions for a measurement value, an AoD, and/or an AoA, among other examples, of a beam at a future time. The output(s) of the AI/ML model 510, as described herein, may facilitate initial access procedures, secondary cell group (SCG) setup procedures, beam refinement procedures (e.g., a P2 beam management procedure or a P3 beam management procedure), link quality or interference adaptation procedure, beam failure and/or beam blockage predictions, and/or radio link failure predictions, among other examples.

In some examples, the first set of beams may be referred to as Set B beams and the second set of beams may be referred to as Set A beams. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In one example, the AI/ML model 510 may perform spatial-domain beam predictions for beams included in the Set A beams based on measurement results of beams included in the Set B beams. As another example, the AI/ML model 510 may perform temporal beam prediction for beams included in the Set A beams based on historic measurement results of beams included in the Set B beams.

The AI/ML model 510 may be implemented as a neural network model that is based at least in part on a neural network function (NNF). In some aspects, a communication standard and/or a network operator may specify functionality for an NNF and/or may assign the NNF an identifier (ID), resulting in a standardized NNF that may be identified by various devices using the assigned ID. To illustrate, the communication standard and/or network operator may specify and/or standardize that an input X (e.g., measurement(s) as described with regard to reference number 515) into a particular NNF results in an output Y (e.g., predicted measurement(s), point of departure, and/or AoD as described with regard to reference number 520). Specifying an NNF based at least in part on an input X and an output Y enables different vendors and/or different devices (e.g., different UEs) to implement a particular NNF (e.g., via the neural network model and/or the AI/ML model 510) in different manners. That is, a particular NNF specified by the communication standard may be implemented and/or supported by multiple models using a vendor-specific implementation.

The communication standard may specify and/or standardize signaling (e.g., messaging such as an information element (IE)) that devices (e.g., a network node and/or a UE) may use to communicate with one another to enable inter-vendor operation of the standardized NNFs. That is, the communication standard may specify signaling that is mandatory for a device to support to enable the inter-operability. Alternatively, or additionally, the communication standard may specify optional signaling and/or messaging that provides additional flexibility to a device, but is not mandatory for a device to support. Accordingly, the device may maintain inter-operability in a wireless network regardless of whether the device ignores or implements the optional signaling.

In some aspects, a neural network model may be characterized by a model structure and/or a parameter set, such as a model ID and/or a default parameter set (e.g., default values and/or a default configuration used to initialize the neural network model). To illustrate, and as described above, the model ID may uniquely identify a neural network model and/or an NNF that receives a particular input X and generates a particular output Y. An example parameter set may include one or more weights of the neural network model, one or more biases of the neural network model, and/or one or more layer connections of the neural network model, and a default parameter set may specify particular values for the weight(s), particular values for the biases, and/or a particular configuration of the layer connections. In some aspects, the parameter set may be location-based and/or configuration-specific. For example, a first location-based set of parameters may use a first set of values that are based at least in part on a first location and/or a second location-based set of parameters may use a second set of values that are based at least in part on a second location. Each set of values may be based at least in part on the respective channel conditions at each location and/or to optimize operation of the neural node network (e.g., improve an accuracy of a predicted output) using channel condition information. As another example, a first configuration-based set of parameters may be based at least in part on a first set of values for a first operating configuration (e.g., resource allocation, operating frequency, and/or network load) and a second configuration-based set of parameters may be based at least in part on a second set of values for a second operating configuration. In a similar manner as the location-based set of parameters, the different sets of values for the configuration-based sets of parameters may be configured to improve and/or optimize operation of the neural network model, such as by improving an accuracy of a predicted output based at least in part on knowledge about a current operating configuration.

A prediction algorithm, such as the AI/ML model 510 and/or a neural network model, may be trained to generate one or more predictions about a future beam and/or future beam set (e.g., the Set B beams). For example, a neural network model may be trained to predict a future measurement metric of a future beam using past data (e.g., a measurement metric and/or a beam direction) and feedback that may be used to correct and/or adjust the neural network model to improve an accuracy of a next prediction. To illustrate, the neural network model may be trained to predict future RSRP(s) for the Set B beams using one or more RSRP measurement metrics that are generated using the Set A beams. In some aspects, the Set A beams may be a first subset of SSBs that are transmitted by a network node, and the set B beams may be a second subset of SSBs that are predicted SSBs. Accordingly, the RSRP measurements may be based at least in part on transmitted SSBs, and the predicted RSRP measurements may be based at least in part on predicted SSBs. Alternatively, or additionally, the neural network model may be trained to predict one or more refinements to a CSI-RS beam that may be used to characterize and/or configure a unicast PDSCH transmission and/or PDCCH transmission. Some example refinements may include a beam direction and/or a beam angle. However, the neural network model may be trained to predict other types of outputs, such as a beam ID for a future beam (e.g., a beam that is best suited for future channel conditions) and/or other measurement metrics. While described as a neural network model, other prediction algorithms and/or other model implementations of the AI/ML model 510 may be trained to predict the various outputs, such as a recursive neural network. Alternatively, or additionally, the prediction algorithm may be implemented, based at least in part, on a traditional algorithm (e.g., fixed programming rather than adaptive programming). The Set A beams and the Set A beams may include the same beams, some of the same beams (e.g., a portion of beams included in the Set A beams may overlap with a portion of beams included in the Set B beams), and/or uniquely different beams from one another.

In some aspects, a network node (e.g., a network node 110) may train and/or maintain the AI/ML model 510 and, based at least in part on changes in the AI/ML model 510, the network node may indicate updates to the AI/ML model 510 to a UE (e.g., UE 120). That is, the network node may configure the AI/ML model 510 at the UE (e.g., via any combination of Layer 1 signaling, Layer 2 signaling, and/or Layer 3 signaling), such as by transmitting an indication of an initial configuration for the AI/ML model 510 and/or updates to the AI/ML model 510. Alternatively, or additionally, the network node may configure and/or execute a respective AI/ML model, such as an AI/ML model that performs complementary functionality to the AI/ML model 510 at the UE.

The use of a prediction algorithm and/or the AI/ML model to predict future beam characteristics may reduce overhead signaling in a wireless network, such as by mitigating the transmission of one or more RSs that are used for beam management and/or uplink feedback from a UE as described with regard to FIG. 4. Alternatively, or additionally, the use of a prediction algorithm may reduce power consumption at a UE by reducing how often the UE receives a signal, generates measurement metrics, and/or transmits feedback. Reducing power consumption at the UE may extend a battery life of a battery at the UE.

As indicated above, FIG. 5 is provided as an example. Other examples may differ from what is described with regard to FIG. 5.

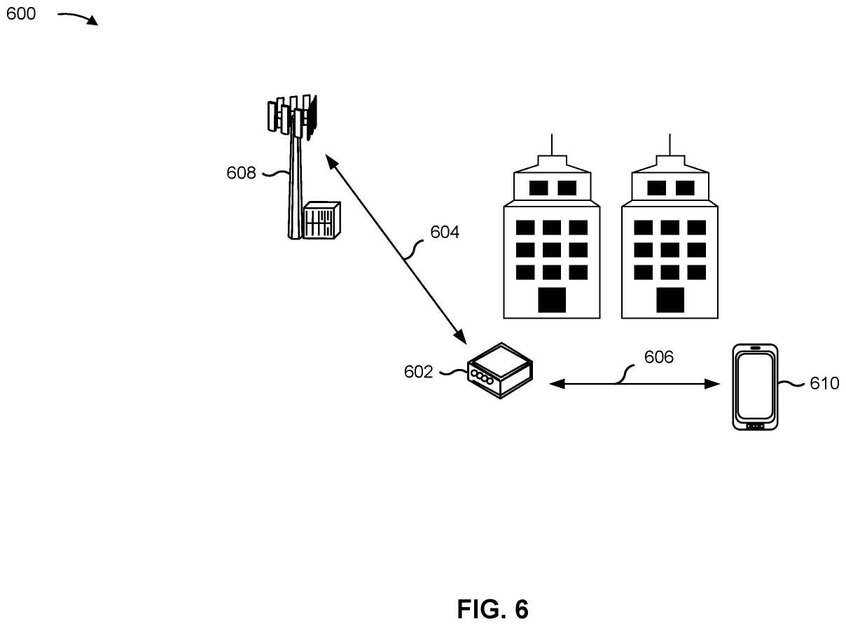

FIG. 6 is a diagram illustrating an example 600 of a repeater device, in accordance with the present disclosure. In some aspects, a repeater device may be implemented as a network node 110.

In some aspects, a wireless communication system may use mmWaves to transmit information and/or data, such as a wireless communication system that is based at least in part on using the above-6-GHz frequencies associated with FR1 and/or FR2. While transmissions that use mmWaves (or higher) may enable a device to transmit or receive the information and/or data at a higher capacity (e.g., a higher data rate or increased data throughput) relative to lower frequencies, the higher frequencies and/or beam transmissions may be more susceptible to adverse channel conditions and/or blockages. As one example, a mmWave may observe increased recovery errors (relative to lower frequencies) based at least in part on a multipath associated with reflections. As described above, some wireless communication systems may use beamforming at higher frequencies to improve a signal quality (e.g., increased power level), increase range and reliability, and/or reduce interference.

Beamforming and/or mmWaves may provide increased data throughput relative to lower frequencies when a transmitter operates in LoS condition with a receiver, but may be more susceptible to disruption by an obstruction and/or blockage that obscures the LoS condition between the devices, such as a hand placed over an antenna, a building, or foliage, which may also result in increased recovery error at a receiver. Some operating environments, such as an indoor operating environment and/or an urban area, may include more obstructions that disrupt an LoS between a transmitter and a receiver. Accordingly, some wireless links may include an intermediary device to mitigate the obstructions, such as a repeater device that amplifies and/or redirects pass-through signals. “Pass-through signal” may denote a signal that is received by a repeater device, amplified by the repeater device, and/or redirected by the repeater device without alterations to content and/or information carried by the pass-through signal. That is, the information and/or content carried by the pass-through signal may be directed to a different recipient than the repeater device, and the repeater device may modify transmission properties of the pass-through signal to improve reception of the pass-through signal by the intended recipient (e.g., by amplifying the signal and/or changing a propagation direction to an LoS propagation direction between the repeater device and a receiver). The use of a repeater device may be associated with one or more operating conditions, such as a latency condition (e.g., to mitigate inter-symbol interference that is associated with a channel delay spread that is greater than a cyclic prefix length), a coverage area condition, and/or a simultaneous support condition (e.g., a number of UEs supported by the repeater device at one time). While a repeater device may be used for relaying mmWaves and/or beamformed signals, the repeater device may alternatively or additionally be used for signals in frequency bands that are different from mmWave frequency bands.

The example 600 includes a repeater device 602 that may be implemented as a network node 110. In some aspects, the repeater device 602 may support modifying transmission parameters (e.g., a power level and/or propagation direction) of one or more pass-through signals (e.g., simultaneously). For instance, and as shown by reference number 604 and reference number 606, the repeater device 602 may repeat a downlink signal from a network node 608 that is directed to a UE 610 (e.g., a downlink signal that is based at least in part on an access link between the network node 608 and the UE 610). In some aspects, the network node 608 may transmit the downlink signal to the repeater device 602 via a backhaul link with the repeater device 602 and/or as part of an access link with the UE 610. Alternatively, or additionally, the repeater device 602 may repeat an uplink signal from the UE 610 to the network node 608.

The use of a repeater device may improve LoS conditions between a network node and a UE, but may increase a signaling overhead for beam management procedures and/or beam predictions. To illustrate, a first beam used by the network node 608 to transmit signals to, and/or receive signals from, the repeater device 602 as shown by reference number 604 may vary in direction relative to a second beam used by the repeater device 602 to transmit signals to, and/or receive signals from, the UE 610, as shown by reference number 606. In some aspects, the repeater device 602 may generate one or more measurement metrics using one or more uplink signals from the UE 610, such as one or more sounding reference signals (SRSs) that are part of a beam sweeping procedure that varies the beams used to carried the SRSs (e.g., an SRS sweep), as part of a beam management procedure for selecting a beam configuration to use between the repeater device 602 and the UE 610. Alternatively, or additionally, the repeater device 602 may transmit the measurement metric(s) to the network node 608 for processing (e.g., beam prediction and/or beam management) and/or selection of the beam configuration to use for communications between the repeater device 602 and the UE 610. However, transmission of an SRS sweep by the UE 610 and/or the transmitting of measurement results by the repeater device 602 and to the network node 608 may result in increased signaling overhead, especially for scenarios that involve the repeater device 602 and/or the UE 610 repeatedly performing the SRS sweep and measurement metric transmission. Increased signaling overhead may result in fewer air interface resources being available for data transmissions, reduce data throughput in a wireless network, and/or increase data transfer latencies in the wireless network. In some aspects, the repeater device 602 performing a second beam management procedure that is additional to a first beam management procedure performed by the network node 608 may alternatively or additionally increase data transfer latencies observed by the UE 610 and/or the network node 608.

Some techniques and apparatuses described herein provide beam prediction module updates at a repeater device. In some aspects, a repeater device may communicate with a UE using a first beam to obtain one or more measurement metrics that indicate the network operating condition, and may predict (e.g., via the AI/ML model) the second beam using the one or more measurement metrics as input.

A prediction algorithm (e.g., the AI/ML model 510) may generate a beam prediction output (e.g., a predicted beam ID, a predicted beam direction, a predicted beam angle of departure, and/or a predicted measurement metric) for an access link and/or a portion of an access link, such as a predicted beam output for a communication link between a repeater device and a UE. Including the prediction algorithm at a repeater device may reduce signaling overhead by reducing signaling overhead between the repeater device and UE and/or signaling overhead between the repeater device and a network node. In some aspects, a network node (e.g., a network node 110) may fully control a beam configuration at the repeater device, which may also be referred to as a network node fully-controlled operating mode. That is, the network node may instruct the repeater device to use a particular beam configuration for a communication link between the repeater device and UE. Accordingly, in the network node fully-controlled operating mode, the repeater device may obtain one or more measurement metrics and may use the measurement metric(s) as input to the prediction algorithm. For example, the repeater device may generate the measurement metric using an uplink signal transmitted by the UE and/or may receive a measurement report (e.g., a CSI report) from the UE. Based at least in part on operating in a network node fully-controlled operating mode, the repeater device may report a beam prediction output generated by the prediction algorithm to the network node, and the network node may transmit a control message to the repeater device that instructs the repeater device to adjust and/or modify a beam configuration. The network node may use the beam prediction output to select a beam configuration that is indicated by the control message.

Alternatively, or additionally, the repeater device may operate in a network node partially-controlled operating mode in which the network node partially controls a beam configuration that is used by the repeater device. In the network node partially-controlled operating mode, the network node may configure an initial beam used by the repeater device, and the repeater device may predict a future beam configuration. For instance, the repeater device may generate a beam prediction output using one or more measurement metric(s) in a similar manner as described above, and the repeater device may autonomously use the beam prediction output to configure and/or reconfigure a beam that is used for the communication link between the repeater device and a UE. That is, the repeater device may select a new beam using the beam prediction output and without waiting for an instruction from the network node. For both a network node fully-controlled operating mode and a network node partially-controlled operating mode, the network node may allocate one or more air interface resources to the UE for uplink communications, such as an SRS air interface resource and/or a PUCCH air interface resource (e.g., for a beam report), and may indicate the allocation to the repeater device. Indicating the air interface resource allocation(s) to the repeater device may enable the repeater device to generate a measurement metric and/or obtain a measurement metric generated by the UE.

A repeater device that implements and/or includes a prediction algorithm may reduce signaling overhead in a wireless network, such as by reducing SRS sweeps performed by a UE and/or reducing a number of measurement metric(s) that are transmitted by the repeater device to the network node. Reducing signaling overhead may reduce air interface resource consumption, resulting in more air interface resources being available for data transmissions, increase data throughput in a wireless network, and/or decrease data transfer latencies in the wireless network. Alternatively, or additionally, the repeater device using a prediction model to predict a future beam may mitigate delays in a wireless network that are associated with running a beam management procedure at the relay device, and reduce data transfer latencies.

As indicated above, FIG. 6 is provided as an example. Other examples may differ from what is described with regard to FIG. 6.

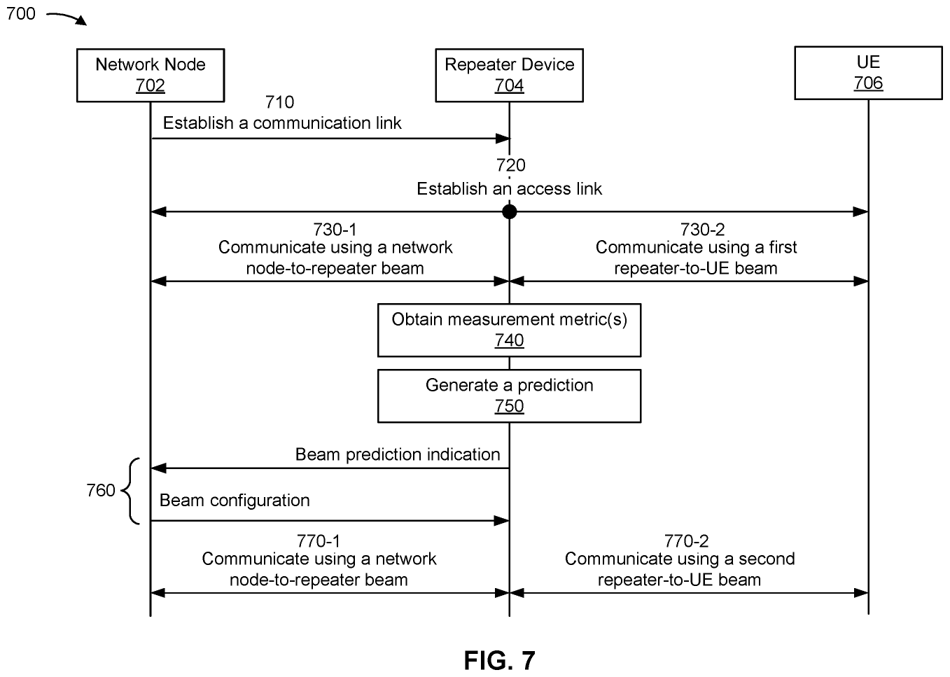

FIG. 7 is a diagram illustrating an example 700 of a wireless communication process between a network node 702 (e.g., a network node 110), a repeater device 704 (e.g., another network node 110), and a UE 706 (e.g., a UE 120), in accordance with the present disclosure.

As shown by reference number 710, a network node 702 and a repeater device 704 may establish a communication link. As one example, the network node 702 and the repeater device 704 may establish a backhaul link. Alternatively, or additionally, the network node 702 and the repeater device 704 may establish an access link (e.g., a network-node-to-repeater-device access link). The network node 702 and the repeater device 704 may communicate via the communication link based at least in part on any combination of Layer 1 signaling, Layer 2 signaling, and/or Layer 3 signaling. “Layer 1 signaling”, “Layer 2 signaling”, and/or “Layer 3 signaling” may denote different levels of signaling messages that are based at least in part on a protocol stack. For instance, Layer 1 signaling may be physical layer (PHY layer) signaling, Layer 2 signaling may be MAC layer signaling, and/or Layer 3 signaling may be radio resource control (RRC) signaling. As one example, the network node 702 may request, via Layer 3 signaling, repeater device capability information, and/or the repeater device 704 may transmit, via Layer 3 signaling, the repeater device capability information. As part of communicating via the communication link, the network node 702 may transmit configuration information via Layer 3 signaling (e.g., RRC signaling), and activate and/or deactivate a particular configuration via Layer 2 signaling (e.g., a MAC control element (CE)).

In some aspects, the network node 702 may transmit an indication of a prediction algorithm, such as an indication of a model ID that is associated with a prediction algorithm specified by a communication standard as described above. As described above, the prediction algorithm may be configured to predict a future beam and/or characteristics about the future beam. Accordingly, the network node 702 may indicate, to the repeater device 704, selection of a particular prediction algorithm to use for beam prediction.

Alternatively, or additionally, the network node 702 may transmit an indication of a network operating condition, and the repeater device 704 may select, apply, and/or use a particular prediction algorithm based at least in part on the network operating condition. To illustrate, the repeater device 704 may support different prediction algorithms and/or AI/ML models. Some prediction algorithms may use a same input (e.g., a same measurement metric), but generate different prediction outputs (e.g., different beam prediction outputs and/or handover outputs) based at least in part on the network operating condition. Alternatively, or additionally, some prediction algorithms may use different inputs (e.g., different measurement metrics) to generate a same prediction output. In some aspects, the repeater device 704 may support different prediction algorithms that use different inputs to generate different prediction outputs from one another. As described above, the network operating condition may indicate a state of a wireless network and/or a configuration of the wireless network. In some aspects, the network operating condition may include a measurement metric that indicates a channel condition.

As one example of a network operating condition, the network node 702 may transmit an indication of one or more node configurations that may change a beam prediction output generated by the repeater device 704. To illustrate, in a network energy saving (NES) mode, one or more network nodes may iteratively and/or periodically transition between an NES on state and an NES off state to reduce power consumption. While operating in an NES on state, a network node may enable transmission and/or reception, and while operating in an NES off state, the network node may disable transmission and/or reception. Accordingly, an applied coverage area provided by the repeater device 704 (e.g., a handover decision boundary) may vary based at least in part on one or more node configurations. For instance, a second network node that is different from the network node 702 may provide a first coverage area that overlaps with a second coverage area of the repeater device 704 such that a handover decision boundary may be biased to selecting a handover to the second network node and/or may reduce an applied coverage area of the repeater device 704.

Based at least in part on the second network node operating in an NES off state, the repeater device 704 may select a first prediction algorithm that is configured to predict a beam configuration that extends the applied coverage area of the repeater device to provide coverage to the UE 706 in the absence of the first coverage area provided by the second network node. Alternatively, or additionally, based at least in part on the second network node operating in an NES on state, the repeater device 704 may select a second prediction algorithm that is configured to predict a beam configuration that reduces the applied coverage area of the repeater device 704 to prioritize coverage by the second network node. Accordingly, the network node 702 may indicate, as the network operating condition, a network operating configuration that indicates an NES mode state (e.g., an NES on state and/or an NES off state) and/or an NES period (e.g., a duration of an NES on state and/or a duration of an NES off state), and the repeater device 704 may select a prediction algorithm using the network operating configuration. In some aspects, the prediction algorithm may output a beam prediction output and/or a handover prediction output (e.g., perform a handover or do not perform an handover) based at least in part on the network operating condition.

Alternatively, or additionally, the network node 702 may indicate, as at least part of a network operating condition and/or a network operating configuration, an RS configuration that specifies one or more characteristics about an RS. For instance, the RS configuration may indicate an air interface resource assigned to the RS, a transmission configuration, and/or an RS type (e.g., a CSI-RS or an SRS). In some aspects, the repeater device 704 may include and/or support different prediction algorithms and/or AI/ML models that may use different inputs and/or may generate different prediction outputs (e.g., a beam prediction output and/or a handover prediction output). For example, a first prediction algorithm and/or first AI/ML model may use one or more CSI-RS RSRP metrics (e.g., of one or more CSI-RS beams and/or feedback by the UE 706) to generate a prediction output. Accordingly, the first prediction algorithm may be selected by the repeater device 704 based at least in part on an RS configuration that indicates a CSI-RS. As another example, a second prediction algorithm and/or second AI/ML model may use one or more SRS RSRP metrics (e.g., generated by the repeater device 704) to generate a prediction output, and the repeater device may select the second prediction algorithm for an RS configuration that indicates an SRS. As yet another example, a third prediction algorithm may use a channel estimation metric (e.g., generated by the repeater device 704 using the SRS) as an input, and the repeater device may select the third prediction algorithm for an RS configuration that indicates an SRS. Accordingly, the network node 702 may indicate an RS configuration as a network operating condition.

In some aspects, the network node 702 may indicate, as at least part of a network operating condition and/or a network operating configuration, an array configuration, such as a number of antenna elements being used in an array configuration. To illustrate, different wireless communication devices (WCDs), such as the network node 702, the repeater device 704, the UE 706, and/or neighboring network nodes, may have different array configurations and/or may use different array configurations. For instance, a first WCD may use a large array configuration (e.g., 256 array elements) to improve a signal quality (e.g., received signal power and/or a beam direction) and a second WCD may use a small array configuration (e.g., 16 array elements) to reduce power consumption. In some aspects, the repeater device 704 may include different prediction algorithms that are configured to generate a prediction output based at last in part on an array configuration used to transmit and/or receive a signal. That is, a first prediction algorithm may be optimized for a transmission generated using a first array configuration (e.g., a large array configuration) and/or a second algorithm may be optimized for a transmission generated using a second array configuration (e.g., a small array configuration). Accordingly, the network node 702 may transmit an indication of an array configuration as at least part of a network operating configuration to enable the repeater device 704 to select a particular prediction algorithm that is optimized for the array configuration.

Selecting an operating-condition-specific prediction algorithm (e.g., that is configured specifically for the network operating condition) may result in the prediction algorithm generating a more accurate prediction, relative to a generic prediction algorithm that is not configured specifically for the network operating condition). Accordingly, the network node 702 may iteratively and/or repeatedly transmit an indication of the network operating condition (e.g., the network operating configuration) to indicate updates to the network operating condition. In some aspects, the network node 702 may periodically transmit an indication of a network operating condition, while in other aspects, the network node 702 may transmit an indication of an update to the network operating condition based at least in part on detecting a trigger condition (e.g., a change in an operating condition that satisfies a threshold). Examples of a network operating condition may include a measurement metric that indicates a channel condition, an array configuration, an RS configuration, an NES state, and/or an NES configuration as described above.

As shown by reference number 720, the network node 702 and a UE 706 may establish a communication link using the repeater device 704, such as an access link (e.g., a network-node-to-UE access link). For instance, the network node 702 may use the repeater device 704 as described with regard to FIG. 6 to relay a downlink communication from the network node 702 to the UE 706 and/or to relay an uplink communication from the UE 706 to the network node 702. The downlink communication may be addressed to and/or directed to the UE 706 and/or the uplink communication may be addressed to and/or directed to the network node 702, such that the repeater device 704 is not an intended recipient of either communication. That is, the downlink communication and/or the uplink communication may be a pass-through signal at the repeater device 704.

In a similar manner as with the communication link described with regard to reference number 710, the network node 702 and the UE 706 may communicate via the communication link based at least in part on any combination of Layer 1 signaling, Layer 2 signaling, and/or Layer 3 signaling. As one example, the network node 702 may request, via Layer 3 signaling, UE capability information, and/or the UE 706 may transmit, via Layer 3 signaling, the UE capability information. As part of communicating via the communication link, the network node 702 may transmit configuration information via Layer 3 signaling (e.g., RRC signaling), and activate and/or deactivate a particular configuration via Layer 2 signaling (e.g., a MAC control element (CE)) and/or Layer 1 signaling (e.g., DCI).

As shown by reference number 730-1, the network node 702 may communicate with the UE 706 via the network-node-to-UE access link and based at least in part on communicating with the repeater device 704 using a network-node-to-repeater beam, such as by the repeater device 704 relaying a communication from the network node 702 to the UE 706 and/or relaying a communication from the UE 706 to the network node 702. Accordingly, and as shown by reference number 730-2, the UE 706 may communicate with the network node 702 via the network-node-to-UE access link and based at least in part on communicating with the repeater device 704 using a first repeater-to-UE beam.

“Network-node-to-repeater beam” may denote a beam that is configured for communications from the network node 702 to the repeater device 704 and/or a beam that is configured for communications from the repeater device 704 to the network node 702 (e.g., as described with regard to reference number 604). Alternatively, or additionally, “network-node-to-repeater beam” may denote one or more beam pairs, such as a first beam pair that includes a first transmit beam and first receive beam used by the network node 702 and the repeater device 704, respectively, for transmitting and receiving a communication from the network node 702 to the repeater device 704 and/or a second beam pair that includes a second transmit beam and a second receive beam used by the repeater device 704 and the network node 702, respectively, for transmitting and receiving a communication from the repeater device 704 to the network node 702.

In a similar manner, “repeater-to-UE beam” may denote a beam that is configured for communications from the repeater device 704 to the UE 706 and/or a beam that is configured for communications from the UE 706 to the repeater device 704 (e.g., as described with regard to reference number 606). Alternatively, or additionally, “repeater-to-UE beam” may denote one or more beam pairs, such as a first beam pair that includes a first transmit beam and first receive beam used by the repeater device 704 and UE 706, respectively, for transmitting and receiving a communication from the repeater device 704 to the UE 706 and/or a second beam pair that includes a second transmit beam and a second receive beam used by the UE 706 and the repeater device 704, respectively, for transmitting and receiving a communication from the UE 706 to the repeater device 704.

As shown by reference number 740, the repeater device 704 may obtain one or more measurement metrics. As one example, the repeater device 704 may obtain the measurement metric(s) by generating the measurement metric(s) using one or more uplink signal(s) from the UE 706, such as an SRS. Alternatively, or additionally, the repeater device 704 may obtain the measurement metrics(s) by receiving a CSI report (e.g., from the UE 706) that indicates a channel condition between the repeater device 704 and the UE 706. In some aspects, the channel condition may indicate a network operating condition, and the repeater device 704 may use the channel condition to select a prediction algorithm.

In some aspects, the repeater device 704 may receive a UE-generated beam report that indicates the measurement metric(s). To illustrate, the repeater device 704 may receive an indication of a dedicated air interface resource (e.g., from the network node 702) that is dedicated to communicating the UE-generated beam report. That is, the dedicated air interface resource may be assigned to a transmission by the UE 706, and/or reception by the repeater device 704, of the UE-generated beam report. Accordingly, the repeater device 704 may receive the UE-generated beam report using the dedicated air interface resource.

Alternatively, or additionally, the repeater device 704 may generate (e.g., calculate) the measurement metric(s) using one or more RS configurations. As one example, the RS configuration may include an SRS configuration, and the measurement metric(s) may include one or more SRS RSRP metric(s) and/or one or more channel estimation metric(s). In some aspects, the repeater device 704 may receive an indication of the RS configuration from the network node 702.

Alternatively, or additionally, the RS configuration may indicate a CSI-RS configuration that indicates one or more characteristics of a CSI-RS. Accordingly, the measurement metric(s) may include one or more CSI-RS RSRP metrics, and the repeater device 704 may receive the measurement metrics in a UE-generated report (e.g., a CSI report).

In some aspects, the repeater device 704 may generate a measurement metric based at least in part on a particular antenna array configuration. As one example, a first antenna array configuration may use more antennas relative to a second antenna array configuration, and the repeater device 704 may generate an RSRP metric that is based at least in part on a large array (e.g., 256 antennas) CSI-RS. As another example, the first antenna array configuration may use fewer antennas relative to the second antenna array configuration, and the repeater device 704 may generate, as the measurement metric, an RSRP metric that is based at least in part on a small array (e.g., 16 antennas) SSB. “Large array CSI-RS” may denote a CSI-RS that is transmitted using a large array antenna and/or a large array configuration, and “small array SSB” may denote an SSB that is transmitted using a small array antenna and/or a small array configuration. As described with regard to reference number 750, the repeater device 704 may select a prediction algorithm based at least in part on the particular array configuration and/or the measurement metric that is based at least in part on an RS transmitted using the particular array configuration.

As shown by reference number 750, the repeater device may generate a prediction that is associated with a beam, such as a predicted measurement metric, a predicted beam ID, and/or a predicted beam characteristic (e.g., a beam direction and/or beam angle). The repeater device 704 may generate the prediction using a prediction algorithm, such as a machine-learning algorithm (e.g., the AI/ML model 510 as described with regard to FIG. 5). As described above, the prediction algorithm may be configured to generate a beam prediction output using a measurement metric as input. In some aspects, the measurement metric may be specific to a particular RS configuration and/or an array configuration. Alternatively, or additionally, the prediction algorithm may be specific to a network operating condition (e.g., a channel condition and/or a network operating configuration). Accordingly, the repeater device 704 may select a particular prediction algorithm that is optimized for the network operating condition to improve an accuracy of a prediction output by the prediction algorithm. Examples of the network operating conditions may include an RS configuration, a measurement metric, an NES mode state, an NES configuration, a channel condition, and/or an array configuration.

In some aspects, the prediction algorithm may be specified by a communication standard and/or indicated to the repeater device 704 by the network node 702 (e.g., via a model ID). Alternatively, or additionally, the implementation of the prediction algorithm may be specific to the repeater device 704. That is, the repeater device 704 may implement a prediction algorithm to satisfy an input and/or output specification by the communication standard. The repeater device 704 may use and/or include multiple prediction algorithms. To illustrate, the repeater device 704 may use a first prediction algorithm that generates a beam prediction output (e.g., based at least in part on the RS configuration and the measurement metric as described above) and/or a second prediction algorithm to regulate a handover decision. That is, the second prediction algorithm may be configured to generate a handover prediction output using the RS configuration and the measurement metric as input. The handover prediction output may indicate to perform a handover of the UE and/or may indicate not to perform the handover. Alternatively, or additionally, a single prediction algorithm may be configured to generate both a beam prediction output and a handover prediction output.

In some aspects, the repeater device 704 may include a prediction algorithm and/or AI/ML module that, as at least part of a beam prediction output, may predict an array configuration trigger condition (e.g., using one or more measurement metrics as input). To illustrate, the prediction algorithm may receive, as input, a first measurement metric (e.g., RSRP) that was generated based at least in part on a first array configuration. In some aspects, the prediction algorithm may generate a second measurement metric that is a predicted measurement metric associated with a second array configuration (and/or the first array configuration). The prediction algorithm may alternatively or additionally output an indication to switch array configurations (and/or not to switch array configurations), such as when a difference between a predicted measurement metric and a generated measurement metric satisfies a threshold (e.g., X decibels (dB)) and/or fails to satisfy the threshold. To illustrate, the array configuration trigger condition may indicate to switch from using a first antenna array configuration that uses fewer antennas relative to a second antenna array configuration (or vice versa). Alternatively, or additionally, the prediction algorithm may be configured and/or trained to output a probability metric that indicates a different array configuration (e.g., relative to a current array configuration) that may improve signal quality by X dB.

In some aspects, a prediction algorithm may output the array configuration trigger condition and/or the probability metric based at least in part on a condition (e.g., a difference threshold) being met. That is, the prediction algorithm may only output the array configuration trigger condition and/or the probability metric when the condition has been met, and the prediction algorithm may not output the array configuration trigger condition and/or the probability metric when the condition has not been met. As described above, the antenna array configuration may be an input to the prediction algorithm, either explicitly as an input parameter and/or implicitly via a measurement metric type. Accordingly, the repeater device 704 may use a prediction algorithm that is configured to output an array configuration trigger condition using a measurement metric as an input and/or an array configuration as an input.

As shown by reference number 760, the repeater device 704 may transmit, and the network node 702 may receive, an indication of a beam configuration (e.g., a predicted beam, a predicted beam characteristic of the predicted beam, and/or a predicted measurement metric associated with the predicted beam). Alternatively, or additionally, the network node 702 may transmit, and the repeater device 704 may receive, an instruction to use the indicated beam configuration. As one example, the repeater device 704 may transmit the indication of the beam configuration, and the network node 702 may transmit the instruction, based at least in part on operating in a network node fully-controlled operating mode.

In some aspects, the repeater device 704 may transmit an indication of an array configuration trigger condition and/or a probability metric that indicates that using a different array configuration is at least X dB better than using a current array configuration. The repeater device 704 may transmit the indication of the array configuration trigger condition and/or the probability metric based at least in part on determining that a condition has been met as described above, and the network node 702 may transmit an instruction to switch from using a first antenna array configuration to a second antenna array configuration (or vice versa). Alternatively, or additionally, the repeater device 704 may transmit an indication of a predicted beam ID that may or may not be associated with a switch in an array configuration, and the network node 702 may transmit an instruction that indicates to begin using a beam indicated by the predicted beam ID.

FIG. 7 illustrates an example of a network node fully-controlled operating scenario. In the network node fully-controlled scenario, the repeater device 704 may indicate a prediction to the network node 702, and may not use the prediction until receiving confirmation from the network node 702, such as the beam configuration that may be based at least in part on the prediction as described with regard to reference number 760. However, in other aspects, the repeater device 704 may autonomously use the prediction without receiving confirmation from the network node 702. That is, some aspects may omit one or more of the signaling transactions described with regard to reference number 760. Accordingly, in some aspects, the repeater device 704 may autonomously adjust to using a predicted beam configuration and/or without receiving an instruction from the network node 702. As another example, the repeater device may autonomously switch from using a first antenna array configuration to using a second antenna array configuration (or vice versa).

In some aspects, the repeater device 704 may transmit an indication of training data that may be used to train a prediction algorithm and/or an AI/ML model. To illustrate, training an AI/ML model may occur at a third-party server (e.g., instead of the repeater device 704 and/or the network node 702). Accordingly, for data collection and/or for training an AI/ML model, the repeater device 704 may transmit an indication of any combination of a measurement metric, a timestamp that indicates a generation time of the measurement metric, and/or an event ID that indicates a trigger event for generating the measurement metric. The network node 702 may forward the training data to the third-party server and, in some aspects, may indicate a network operating condition and/or a network operating configuration associated with the training data. The repeater device 704 may transmit the training data while operating in the network node fully-controlled operating mode and/or the network node partially-controlled operating mode.

As shown by reference number 770-1, the network node 702 may communicate with the UE 706 via the access link (e.g., the network-node-to-UE access link) and based at least in part on communicating with the repeater device 704 using a network-node-to-repeater beam in a similar manner as described with regard to reference number 730-1. Alternatively, or additionally, and as shown by reference number 770-2, the UE 706 may communicate with the network node 702 via the access link (e.g., the network-node-to-UE access link) and based at least in part on the repeater device 704 communicating with the UE 706 using a second repeater-to-UE beam. As described above, the second repeater-to-UE beam may be predicted by the repeater device 704.

A repeater device that includes a prediction algorithm may reduce signaling overhead in a wireless network, such as by reducing SRS sweeps performed by a UE and/or reducing a number of measurement metrics that are transmitted by the repeater device to the network node. Reducing signaling overhead may reduce air interface resource consumption, resulting in more air interface resources being available for data transmissions, an increase in data throughput in a wireless network, and/or a decrease data transfer latencies in the wireless network. Alternatively, or additionally, the repeater device using a prediction model to predict a future beam may mitigate delays in a wireless network that are associated with running a beam management procedure at the relay device, and reduce data transfer latencies.

As indicated above, FIG. 7 is provided as an example. Other examples may differ from what is described with regard to FIG. 7.

FIG. 8 is a diagram illustrating an example process 800 performed, for example, at a repeater device or an apparatus of a repeater device, in accordance with the present disclosure. Example process 800 is an example where the apparatus or the repeater device (e.g., repeater device 704 and/or apparatus 900) performs operations associated with beam prediction at a repeater device.

As shown in FIG. 8, in some aspects, process 800 may include communicating with a UE using a first beam, the communicating comprising relaying an access link communication between the UE and a network node (block 810). For example, the repeater device (e.g., using reception component 902, transmission component 904, and/or communication manager 906, depicted in FIG. 6) may communicate with a UE using a first beam, the communicating comprising relaying an access link communication between the UE and a network node, as described above.

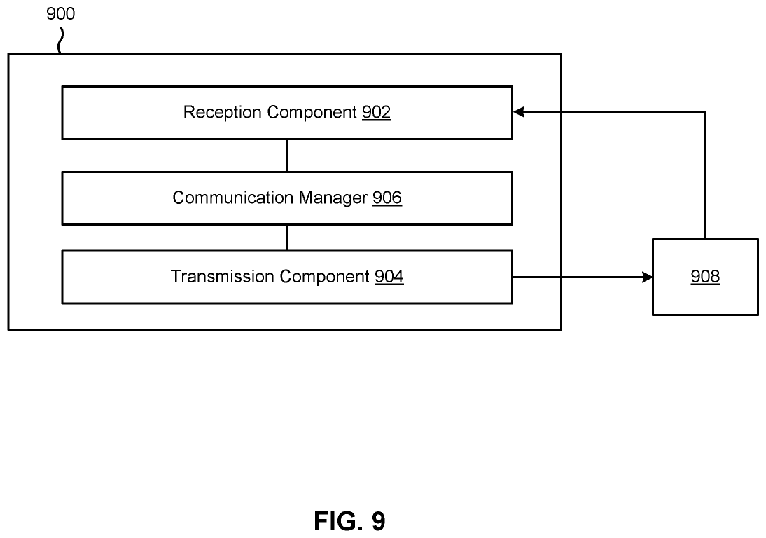

As further shown in FIG. 8, in some aspects, process 800 may include using a second beam that is predicted by the repeater device to communicate with the UE, the second beam being based at least in part on a network operating condition (block 820). For example, the repeater device (e.g., using communication manager 906, depicted in FIG. 9) may use a second beam that is predicted by the repeater device to communicate with the UE, the second beam being based at least in part on a network operating condition, as described above.

Process 800 may include additional aspects, such as any single aspect or any combination of aspects described below and/or in connection with one or more other processes described elsewhere herein.

In a first aspect, process 800 includes obtaining one or more measurement metrics that indicate the network operating condition, and predicting the second beam using the one or more measurement metrics.

In a second aspect, process 800 includes transmitting an indication of the second beam to the network node, and receiving an instruction to use the second beam to communicate with the UE.

In a third aspect, using the second beam includes adjusting to using the second beam autonomously.

In a fourth aspect, obtaining the one or more measurement metrics includes generating the one or more measurement metrics using an uplink signal from the UE.

In a fifth aspect, obtaining the one or more measurement metrics includes receiving a channel state information report that indicates, as the network operating condition, a channel condition between the repeater device and the UE.

In a sixth aspect, process 800 includes receiving an indication of a dedicated air interface resource for communicating a UE-generated beam report, and receiving the UE-generated beam report using the dedicated air interface resource.

In a seventh aspect, process 800 includes receiving an indication of a prediction algorithm, and using the prediction algorithm to predict the second beam.

In an eighth aspect, the prediction algorithm includes a machine-learning algorithm.

In a ninth aspect, process 800 includes receiving an indication of the network operating condition, and selecting a prediction algorithm to use for predicting the second beam based at least in part on the network operating condition.

In a tenth aspect, the network operating condition includes a network operating configuration.

In an eleventh aspect, the network operating configuration includes at least one of one or more network-node-specific NES mode states, an NES period, an RS configuration, or an antenna array configuration.

In a twelfth aspect, process 800 includes generating a measurement metric using an RS configuration, and predicting the second beam using the measurement metric as an input to a prediction algorithm that is specific to the RS configuration and the measurement metric.

In a thirteenth aspect, the RS configuration includes CSI-RS configuration information, and the measurement metric includes a CSI-RS RSRP metric.

In a fourteenth aspect, the RS configuration includes an SRS configuration information, and the measurement metric includes an SRS RSRP metric.

In a fifteenth aspect, the RS configuration includes SRS configuration information, and the measurement metric includes a channel estimation metric.

In a sixteenth aspect, the prediction algorithm is a first prediction algorithm that generates a beam prediction output based at least in part on the RS configuration and the measurement metric, and process 800 includes using a second prediction algorithm to regulate a handover decision, the second prediction algorithm configured to generate a handover output based at least in part on using the RS configuration and the measurement metric as input.

In a seventeenth aspect, process 800 includes transmitting an indication of at least one of the measurement metric, a timestamp that indicates a generation time of the measurement metric, or an event ID that indicates a trigger event for generating the measurement metric.

In an eighteenth aspect, process 800 includes generating a measurement metric using a first antenna array configuration, and predicting an array configuration trigger condition using the measurement metric, the array configuration trigger condition indicating whether to use the first antenna array configuration or to switch to a second antenna array configuration.

In a nineteenth aspect, the first antenna array configuration uses fewer antennas relative to the second antenna array configuration, and the measurement metric is an RSRP metric that is based at least in part on a small array SSB.

In a twentieth aspect, the first antenna array configuration uses more antennas relative to the second antenna array configuration, and the measurement metric is an RSRP metric that is based at least in part on a large array CSI-RS.

In a twenty-first aspect, the array configuration trigger condition is based at least in part on a threshold.

In a twenty-second aspect, the array configuration trigger condition indicates to switch to the second antenna array configuration, and process 800 includes transmitting an indication of the array configuration trigger condition, and receiving an instruction to switch from using the first antenna array configuration to the second antenna array configuration.

In a twenty-third aspect, process 800 includes transmitting, with the indication of the array configuration trigger condition, a predicted beam ID.

In a twenty-fourth aspect, the array configuration trigger condition indicates to switch to the second antenna array configuration, and process 800 includes switching, autonomously, from using the first antenna array configuration to the second antenna array configuration.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a repeater device, or a repeater device may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 6-7. Additionally, or alternatively, the apparatus 900 may be configured to perform one or more processes described herein, such as process 800 of FIG. 8, or a combination thereof. In some aspects, the apparatus 900 and/or one or more components shown in FIG. 9 may include one or more components of the repeater device described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the repeater device described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the repeater device described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 and/or the transmission component 904 may communicate with a UE using a first beam, the communicating comprising relaying an access link communication between the UE and a network node. The communication manager 906 may use a second beam that is predicted by the repeater device to communicate with the UE, the second beam being based at least in part on a network operating condition.

The reception component 902 may obtain one or more measurement metrics that indicate the network operating condition. In some aspects, the communication manager 906 may predict the second beam using the one or more measurement metrics. Alternatively, or additionally, the transmission component 904 may transmit an indication of the second beam to the network node, and/or the reception component 902 may receive an instruction to use the second beam to communicate with the UE.

The reception component 902 may receive an indication of a dedicated air interface resource for communicating a UE-generated beam report. In some aspects, the reception component 902 may receive the UE-generated beam report using the dedicated air interface resource.

The reception component 902 may receive an indication of a prediction algorithm. In some aspects, the communication manager 906 may use the prediction algorithm to predict the second beam. Alternatively, or additionally, the reception component 902 may receive an indication of the network operating condition. In some aspects, the communication manager 906 may select a prediction algorithm to use for predicting the second beam based at least in part on the network operating condition.

The communication manager 906 may generate a measurement metric using an RS configuration. Alternatively, or additionally, the communication manager 906 may predict the second beam using the measurement metric as an input to a prediction algorithm that is specific to the RS configuration and the measurement metric. In some aspects, the transmission component 904 may transmit an indication of at least one of the measurement metric, a timestamp that indicates a generation time of the measurement metric, or an event ID that indicates a trigger event for generating the measurement metric.

The communication manager 906 may generate a measurement metric using a first antenna array configuration. Alternatively, or additionally, the communication manager 906 may predict an array configuration trigger condition using the measurement metric, the array configuration trigger condition indicating whether to use the first antenna array configuration or to switch to a second antenna array configuration. In some aspects, the transmission component 904 may transmit, with the indication of the array configuration trigger condition, a predicted beam ID.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a repeater device, comprising: communicating with a user equipment (UE) using a first beam, the communicating comprising relaying an access link communication between the UE and a network node; and using a second beam that is predicted by the repeater device to communicate with the UE, the second beam being based at least in part on a network operating condition.

Aspect 2: The method of Aspect 1, further comprising: obtaining one or more measurement metrics that indicate the network operating condition; and predicting the second beam using the one or more measurement metrics.

Aspect 3: The method of Aspect 2, further comprising: transmitting an indication of the second beam to the network node; and receiving an instruction to use the second beam to communicate with the UE.

Aspect 4: The method of Aspect 2, wherein using the second beam comprises: adjusting to using the second beam autonomously.

Aspect 5: The method of Aspect 2, wherein obtaining the one or more measurement metrics comprises: generating the one or more measurement metrics using an uplink signal from the UE.

Aspect 6: The method of Aspect 2, wherein obtaining the one or more measurement metrics comprises: receiving a channel state information report that indicates, as the network operating condition, a channel condition between the repeater device and the UE.

Aspect 7: The method of any of Aspects 1-6, further comprising: receiving an indication of a dedicated air interface resource for communicating a UE-generated beam report; and receiving the UE-generated beam report using the dedicated air interface resource.

Aspect 8: The method of any of Aspects 1-7, further comprising: receiving an indication of a prediction algorithm; and using the prediction algorithm to predict the second beam.

Aspect 9: The method of Aspect 8, wherein the prediction algorithm comprises a machine-learning algorithm.

Aspect 10: The method of any of Aspects 1-9, further comprising: receiving an indication of the network operating condition; and selecting a prediction algorithm to use for predicting the second beam based at least in part on the network operating condition.

Aspect 11: The method of Aspect 10, wherein the network operating condition comprises a network operating configuration.

Aspect 12: The method of Aspect 11, wherein the network operating configuration comprises at least one of: one or more network-node-specific network energy saving (NES) mode states, an NES period, a reference signal (RS) configuration, or an antenna array configuration.

Aspect 13: The method of any of Aspects 1-12, further comprising: generating a measurement metric using a reference signal (RS) configuration; and predicting the second beam using the measurement metric as an input to a prediction algorithm that is specific to the RS configuration and the measurement metric.

Aspect 14: The method of Aspect 13, wherein the RS configuration comprises channel state information reference signal (CSI-RS) configuration information, and wherein the measurement metric comprises a CSI-RS reference signal received power (RSRP) metric.

Aspect 15: The method of Aspect 13, wherein the RS configuration comprises sounding reference signal (SRS) configuration information, and wherein the measurement metric comprises an SRS reference signal received power (RSRP) metric.

Aspect 16: The method of Aspect 13, wherein the RS configuration comprises sounding reference signal (SRS) configuration information, and wherein the measurement metric comprises a channel estimation metric.

Aspect 17: The method of Aspect 13, wherein the prediction algorithm is a first prediction algorithm that generates a beam prediction output based at least in part on the RS configuration and the measurement metric, and wherein the method further comprises: using a second prediction algorithm to regulate a handover decision, the second prediction algorithm configured to generate a handover output based at least in part on using the RS configuration and the measurement metric as input.

Aspect 18: The method of Aspect 13, further comprising: transmitting an indication of at least one of: the measurement metric, a timestamp that indicates a generation time of the measurement metric, or an event identifier (ID) that indicates a trigger event for generating the measurement metric.

Aspect 19: The method of any of Aspects 1-18, further comprising: generating a measurement metric using a first antenna array configuration; and predicting an array configuration trigger condition using the measurement metric, the array configuration trigger condition indicating whether to use the first antenna array configuration or to switch to a second antenna array configuration.

Aspect 20: The method of Aspect 19, wherein the first antenna array configuration uses fewer antennas relative to the second antenna array configuration, and wherein the measurement metric is a reference signal received power (RSRP) metric that is based at least in part on a small array synchronization signal block (SSB).

Aspect 21: The method of Aspect 19, wherein the first antenna array configuration uses more antennas relative to the second antenna array configuration, and wherein the measurement metric is a reference signal received power (RSRP) metric that is based at least in part on a large array channel state information reference signal (CSI-RS).

Aspect 22: The method of Aspect 19, wherein the array configuration trigger condition is based at least in part on a threshold.

Aspect 23: The method of Aspect 19, wherein the array configuration trigger condition indicates to switch to the second antenna array configuration, and wherein the method further comprises: transmitting an indication of the array configuration trigger condition; and receiving an instruction to switch from using the first antenna array configuration to the second antenna array configuration.

Aspect 24: The method of Aspect 23, further comprising: transmitting, with the indication of the array configuration trigger condition, a predicted beam identifier (ID).

Aspect 25: The method of Aspect 19, wherein the array configuration trigger condition indicates to switch to the second antenna array configuration, and wherein the method further comprises: switching, autonomously, from using the first antenna array configuration to the second antenna array configuration.

Aspect 26: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-25.

Aspect 27: An apparatus for wireless communication at a device, the apparatus comprising one or more memories and one or more processors coupled to the one or more memories, the one or more processors configured to cause the device to perform the method of one or more of Aspects 1-25.

Aspect 28: An apparatus for wireless communication, the apparatus comprising at least one means for performing the method of one or more of Aspects 1-25.

Aspect 29: A non-transitory computer-readable medium storing code for wireless communication, the code comprising instructions executable by one or more processors to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

Aspect 31: A device for wireless communication, the device comprising a processing system that includes one or more processors and one or more memories coupled with the one or more processors, the processing system configured to cause the device to perform the method of one or more of Aspects 1-25.

Aspect 32: An apparatus for wireless communication at a device, the apparatus comprising one or more memories and one or more processors coupled to the one or more memories, the one or more processors individually or collectively configured to cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a repeater device, comprising:
one or more memories; and
one or more processors, coupled to the one or more memories, configured to cause the repeater device to:
communicate with a user equipment (UE) using a first beam, the one or more processors, to cause the repeater to communicate with the UE, are further configured to cause the repeater device to:
relay an access link communication between the UE and a network node; and
use a second beam that is predicted by the repeater device to communicate with the UE, the second beam being based at least in part on a network operating condition.

2. The apparatus of claim 1, wherein the one or more processors are further configured to cause the repeater device to:
obtain one or more measurement metrics that indicate the network operating condition; and
predict the second beam using the one or more measurement metrics.

3. The apparatus of claim 2, wherein the one or more processors are further configured to cause the repeater device to:
transmit an indication of the second beam to the network node; and
receive an instruction to use the second beam to communicate with the UE.

4. The apparatus of claim 2, wherein the one or more processors, to cause the repeater device to use the second beam, are configured to cause the repeater device to:
adjust to using the second beam autonomously.

5. The apparatus of claim 2, wherein the one or more processors, to cause the repeater device to obtain the one or more measurement metrics, are configured to cause the repeater device to:
generate the one or more measurement metrics using an uplink signal from the UE.

6. The apparatus of claim 2, wherein the one or more processors, to cause the repeater device to obtain the one or more measurement metrics, are configured to cause the repeater device to:
receive a channel state information report that indicates, as the network operating condition, a channel condition between the repeater device and the UE.

7. The apparatus of claim 1, wherein the one or more processors are further configured to cause the repeater device to:
receive an indication of a prediction algorithm; and
use the prediction algorithm to predict the second beam.

8. The apparatus of claim 1, wherein the one or more processors are further configured to cause the repeater device to:
receive an indication of the network operating condition; and
select a prediction algorithm to use for predicting the second beam based at least in part on the network operating condition.

9. The apparatus of claim 1, wherein the one or more processors are further configured to cause the repeater device to:
generate a measurement metric using a reference signal (RS) configuration; and
predict the second beam using the measurement metric as an input to a prediction algorithm that is specific to the RS configuration and the measurement metric.

10. The apparatus of claim 9, wherein the prediction algorithm is a first prediction algorithm that generates a beam prediction output based at least in part on the RS configuration and the measurement metric, and
wherein the one or more processors are further configured to cause the repeater device to:
use a second prediction algorithm to regulate a handover decision, the second prediction algorithm configured to generate a handover output based at least in part on using the RS configuration and the measurement metric as input.

11. The apparatus of claim 1, wherein the one or more processors are further configured to cause the repeater device to:
generate a measurement metric using a first antenna array configuration; and
predict an array configuration trigger condition using the measurement metric, the array configuration trigger condition indicating whether to use the first antenna array configuration or to switch to a second antenna array configuration.

12. A method of wireless communication performed by a repeater device, comprising:
communicating with a user equipment (UE) using a first beam, the communicating comprising relaying an access link communication between the UE and a network node; and
using a second beam that is predicted by the repeater device to communicate with the UE, the second beam being based at least in part on a network operating condition.

13. The method of claim 12, further comprising:
obtaining one or more measurement metrics that indicate the network operating condition; and
predicting the second beam using the one or more measurement metrics.

14. The method of claim 12, further comprising:
receiving an indication of a prediction algorithm; and
using the prediction algorithm to predict the second beam.

15. The method of claim 12, further comprising:
receiving an indication of the network operating condition; and
selecting a prediction algorithm to use for predicting the second beam based at least in part on the network operating condition.

16. The method of claim 12, further comprising:
generating a measurement metric using a reference signal (RS) configuration; and
predicting the second beam using the measurement metric as an input to a prediction algorithm that is specific to the RS configuration and the measurement metric.

17. The method of claim 12, further comprising:
generating a measurement metric using a first antenna array configuration; and
predicting an array configuration trigger condition using the measurement metric, the array configuration trigger condition indicating whether to use the first antenna array configuration or to switch to a second antenna array configuration.

18. A non-transitory computer-readable medium storing a set of instructions for wireless communication, the set of instructions comprising:
one or more instructions that, when executed by one or more processors of a repeater device, cause the repeater device to:
communicate with a user equipment (UE) using a first beam, the one or more instructions, to cause the repeater device to communicate with the UE, are further configured to cause the repeater device to:
relay an access link communication between the UE and a network node; and
use a second beam that is predicted by the repeater device to communicate with the UE, the second beam being based at least in part on a network operating condition.

19. The non-transitory computer-readable medium of claim 18, wherein the one or more instructions further cause the repeater device to:
obtain one or more measurement metrics that indicate the network operating condition; and
predict the second beam using the one or more measurement metrics.

20. The non-transitory computer-readable medium of claim 18, wherein the one or more instructions further cause the repeater device to:
receive an indication of the network operating condition; and
select a prediction algorithm to use for predicting the second beam based at least in part on the network operating condition.
